(19) United States
(12) Patent Application Publication
(10) Pub. No.: US 2014/0326674 A1
(43) Pub. Date: Nov. 6, 2014

(54) Zero Liquid Discharge Method for High Silica Solutions

(71) Applicant: CHEMTREAT, INC., Glen Allen, VA (US)

(72) Inventor: John Richardson, Hanvoer, VA (US)

(21) Appl. No.: 14/155,349

(22) Filed: Jan. 14, 2014

Related U.S. Application Data
(60) Provisional application No. 61/752,436, filed on Jan. 14, 2013.

(51) Int. Cl. C02F 1/52

(52) U.S. Cl. CPC C02F 1/52
USPC 210/696; 210/702; 210/710; 210/712

(57) ABSTRACT

Disclosed are zero liquid discharge (ZLD) processes that utilize naturally occurring or supplemental silicate in the water supply for removing magnesium and calcium hardness from aqueous alkaline streams in the form of a silica gel, thereby allowing separation of a low hardness supernant for recycling.

### PRIORITY STATEMENT

This application claims priority under 35 U.S.C. §119(e) from U.S. Provisional Application No. 61/752,436, filed Jan. 14, 2013, the contents of which are incorporated, by reference, in their entirety.

### BACKGROUND

Steam assisted gravity drainage (SAGD) processes generate large quantities of produced water that is typically characterized by a combination of relatively low hardness (calcium and magnesium) and high silica (SiO₂) content. SAGD processes inject steam and liquid into oil formations in order to lower the viscosity of the oil, thereby allowing a solution of the injected solution and oil to be extracted through a collection wellhead. The oil and aqueous portions of the recovered liquid are then separated from each other with the aqueous portion being referred to as produced water. This produced water must then be processed as either a waste stream or as a recycle stream. As a result of environmental restrictions and the cost associated with acquiring replacement feed water, recycling processes tend to be preferred.

Two main processes are currently being utilized for recycling produced water. The more traditional process uses once through steam generators (OTSG) to process the produced water and generate new steam for the injection cycle. A newer process uses high-pressure packaged boilers for steam generation, which provide a greater recovery of water for steam injection. The packaged boilers, however, tend to need higher quality feedwater (feedwater having a low silica content) relative to that tolerated in an OTSG. Various processes have been utilized for providing this higher quality feedwater including, for example, reverse osmosis (RO) processes operating at high pH and a range of evaporative processes.

Both the pretreatment processes for packaged boilers and the steam generation operations tend to produce a waste or blowdown stream that is characterized by both a high pH (to improve silica solubility) and silica levels greater than 5000 ppm. These blowdown streams present certain disposal issues as they are generally not suitable for deep well injection because of the risk that precipitating silica will plug the formation. Although a number of conventional water treatment processes have been used in addressing these issues, there remains substantial room for improvement.

One blowdown treatment option that has been adapted to reduce the difficulties associated with the waste disposal aspects are zero liquid discharge (ZLD) processes. These processes use a variety of techniques including, for example, using a crystallizing evaporator and applying mechanical dewatering technique(s) to the resulting solids. The widespread use of anti-scalants in the injection solution, and the corresponding presence of these anti-scalants in the produced water, however, tends to inhibit the formation of true form crystals in the crystallizer that complicate subsequent filtration efforts. Systems have been modified to replace the mechanical dewatering equipment with rotary drum driers that, while effective, tend to increase both capital and operating expenses.

Another option that has been considered is acidification of the blowdown solution followed by lagoon settling with the addition of coagulants/flocculants. Typically, two or more lagoons are required whereby at least one can be available to receive the concentrated solution/slurry while another lagoon is being dried for solids removal and a new fill cycle. The supernatant removed from the filling lagoon(s) can then be filtered to remove additional colloidal particles and deep well injected. The land area required for the lagoons and the complications associated with lagoon processes in cold or unduly humid climates present serious limitations to this option.

Another option has been considered in which the produced water feed to the evaporator section is acidified and fed into a preferential deposition seeded slurry of calcium sulfate (CaSO₄) which is circulated in the evaporator. This process utilizes the precipitating CaSO₄ to adsorb and remove silica from the solution. This process can work fairly well for those solutions that contain sufficient calcium and sulfate ions to initiate precipitation. The precipitated solids can then be removed using conventional mechanical dewatering equipment to leave a filtrate suitable for deep well injection. In many instances, however, the feedwater used in SAGD is characterized by relatively low levels of both calcium and sulfate that would require supplementation, typically through the addition of calcium chloride (CaCl₂) and sodium sulfate (Na₂SO₄) in order to obtain the desired concentrations for precipitation. The cost of these chemicals and the associated feed equipment tends to become prohibitive when the produced water silica content is greater than 200 ppm because of the volume of chemicals that must be added in order to achieve the target precipitating CaSO₄:SiO₂ ratio, a ratio typically on the order of 5:1.

The fourth option that has been considered utilizes a high pH evaporator followed by acidification and mechanical dewatering of the solids. These processes have, however, been plagued by the presence of light colloidal silica particles in the rapid agitation reaction vessel that are difficult to flocculate and filter effectively without the use of clarifiers, thickeners, and heavy doses of coagulants/flocculants.

Descriptions of various ZLD processes and techniques may be found, for example, in U.S. Pat. Nos. 7,591,309; 7,905,283; 8,048,311 and 8,062,530, the contents of which are hereby incorporated, in their entirety, by reference.

### BRIEF DESCRIPTION

Zero Liquid Discharge (ZLD) processes are those that have a goal of completely eliminating liquid discharge from a system. In practice, however, most ZLD process dramatically reduce, if not complete eliminate, the volume of wastewater that requires treatment, process this wastewater in an economically feasible manner, produce a clean stream suitable for reuse elsewhere in the facility and produce solid waste that does not present any particular disposal concerns. Interest in ZLD technology has grown in the industrial manufacturing sector over the past decade in light of more challenging wastewater disposal regulations, company mandated green initiatives, public perception of industrial impact on the environment and/or concern over the quality and quantity of the water supply.

ZLD processes can be both financially and environmentally beneficial for a range of industrial and municipal organizations and can be applied in a number of situations including, for example, operation of boilers, cooling towers, evaporators, and produced water generators. The ZLD processes can be configured for removing targeted dissolved solids from a wastewater or blowdown stream and returning treated water to the process (source).

ZLD processes can be used in conjunction with other technologies including, for example, RO operations configured for concentrating a portion of a waste stream and returning a clean permeate before the ZLD operation. In such cases, a much smaller volume (the RO reject stream) will require treatment in the ZLD operation, thereby improving performance and reducing power consumption. In addition to RO operations, falling film evaporation can be used for concentrating the waste stream(s) or brine before crystallization. Falling film evaporation is fairly efficient and is typically used for concentrating the wastewater stream up to an initial crystallization point. The resulting brine is then typically fed into a forced-circulation crystallizer for increasing the mineral content beyond the solubility of the targeted contaminants and inducing precipitation of the mineral solids. The precipitate-laden brine is then dewatered using, for example, a filter press or centrifuge, with the filtrate or centrate (also called “mother liquor”) being returned to the crystallizer. The collected condensate(s) and permeate(s) from the membranes, falling film evaporator and forced-circulation crystallizer can then be returned to the process, thereby eliminating the discharge of liquids.

The equipment needed to achieve ZLD varies depending on the characteristics of the wastewater as well as the wastewater volume. Typical waste streams in an industrial setting include wastewater treatment reject typically from reverse osmosis (RO) or ion exchange, cooling tower blow down, spent coolants, deionized water (DI) regenerant and/or other wastewaters generated during metal finishing, tank or equipment washing wastewaters, compressor condensate and floor scrubber wash waters.

The invention utilizes naturally occurring or supplemental silicate in the water supply to achieve a ZLD process. As noted above, the feedwater sources available at a number of SAGD operations tend to be characterized by high silica content, but relatively low calcium and magnesium hardness. The silica in such systems tends to be relatively stable at levels around 5000 ppm as long as a relatively high pH is maintained (typically in the range 11.0-12.0). This pH level promotes the formation of HSiO₃⁻ which is soluble and does not tend to form deposits with calcium or magnesium deposits. This high silicate concentration can, in turn, be used to induce gel formation at lower pH levels in a process for achieving zero liquid discharge.

Disclosed are a variety of methods for treating an aqueous alkaline stream having a high silica content in order to reduce liquid discharge comprising reducing an initial pH of the aqueous stream to a treatment pH sufficient to induce formation of a silica gel and a supernant; and separating the silica gel from the supernant. Various additional process steps may be combined with the basic treatment method including, for example, dewatering the silica gel, drying the dewatered silica gel to form a dry waste stream, recycling the supernant, and subjecting the dry waste stream to additional processing to convert it into a saleable product.

The methods of treating an aqueous alkaline stream having a high silica content disclosed herein will typically be utilized in the treatment of aqueous streams having an initial (or modified) silica content of at least 1000 ppm, more typically about 5000 ppm and, depending on the particular water chemistry even in excess of 25,000 ppm silica. While the aqueous alkaline stream will typically have an initial pH of 11.0 or more in order to maintain the silica solubility, the treatment pH may include both alkaline and acid pH values, with a treatment pH range of from about 6.0 to 9.0 being effective for most aqueous alkaline streams. The initial pH may be reduced to the treatment pH using a variety of techniques including the addition of acidic solutions of inorganic acids, organic acids or gases, such as CO₂, that will dissolve in the aqueous alkaline stream and reduce the pH.

In those instances in which the aqueous alkaline stream includes one or more chelants, the effectiveness of the hardness removal with the silica gel formation will be increased if the aqueous alkaline stream is treated in a manner that reduces or suppresses the effectiveness of the chelant compound(s) present before formation of the silica gel. The treatment, sitting or settling period, i.e., the time allowed for the silica gel formation after the treatment pH has been reached will affect the amount of gel formed and the effectiveness of the hardness removal by that gel. A treatment period will typically be selected to ensure that at least 90% of the silica content of the aqueous alkaline stream is captured in the silica gel before separating the silica gel from the supernant.

### BRIEF DESCRIPTION OF THE DRAWINGS

Example embodiments of the invention are described more fully below with reference to the attached drawings in which:

FIG. 1 illustrates the results of an experiment for inducing the formation of gel from a high pH, high silica solution;

FIG. 2 illustrates the results of an experiment for inducing the formation of gel from a high pH, high silica solution after the supernant has been removed from the sample tubes leaving the residual silica gel;

FIGS. 3A and 3B illustrate the results of an experiment for inducing the formation of gel from a high pH, high silica solution with FIG. 3A illustrating the acidified solution after sitting for 15 minutes for silica gel formation and FIG. 3B illustrating the silica gel packing achieved after 10 minutes of centrifuge processing.

FIGS. 4A and 4B illustrate the results of an experiment for inducing the formation of gel from a high pH, high silica solution using sulfuric acid for reducing the initial pH;

FIGS. 5A and 5B illustrate the results of an experiment for inducing the formation of gel from a high pH, high silica solution showing the recovered silica gel before, FIG. 5A, and after, FIG. 5B, drying;

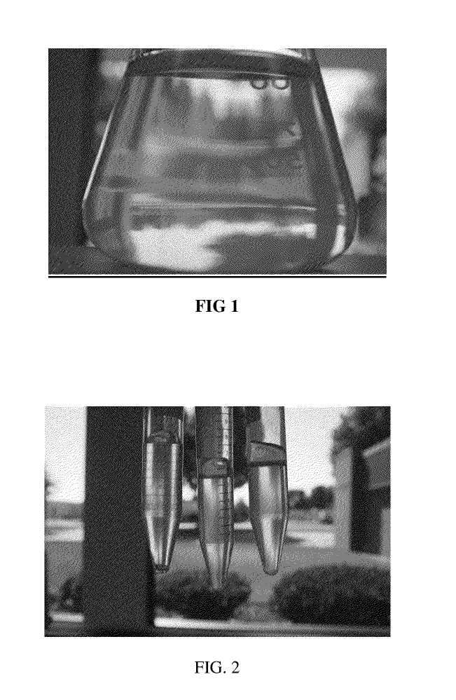

It should be noted that these FIGURES are intended to illustrate the general characteristics of the methods disclosed and certain example embodiments of the invention in order to supplement the detailed written description provided below.

### DETAILED DESCRIPTION

The first step to achieving a substantially zero liquid discharge (ZLD) process is to look for ways of limiting the amount of wastewater that needs to be treated. Reducing the amount of wastewater almost always provides quick payback. For example, pre-treating the water going to a cooling tower to reduce hardness and/or silica can increase the allowable percentage of the feed water can be lost to evaporation before the mineral content of the residual water exceeds the relevant target and must be removed from the system through blowdown or an equivalent process (increasing the cycles of concentration (COC) or simply “cycles”) as a wastewater stream.

Once the sources of the wastewater are identified, the wastewater volume is reduced and the content of those wastewater streams is analyzed, the appropriate equipment and techniques can be selected and evaluated. A traditional approach to ZLD utilizes some form of filtration technology, funnels the reject waters to an evaporator, and sends the evaporator concentrate to a crystallizer or spray dryer. While effective, the equipment and energy necessary to generate and dewater the concentrate slurry tends to involve substantial capital and operating costs thereby limiting the cost effectiveness, particularly for those addressing smaller operations.

The new ZLD processes disclosed herein utilize naturally occurring or supplemental silicate in the water supply. As noted above, the feedwater sources available at a number of SAGD operations tend to be characterized by high silica content, but relatively low calcium and magnesium hardness. The silica in such systems tends to be relatively stable at levels around 5000 ppm as long as a relatively high pH is maintained (typically in the range 11.0-12.0). This pH level promotes the formation of hydrogen silicate ions HSiO₃⁻ which are soluble and do not tend to form deposits with the lower levels of calcium and/or magnesium ions present in the solution. This high silicate concentration can, in turn, be used to induce gel formation at lower pH levels in a process for achieving zero liquid discharge.

Having obtained this process stream of sufficiently high silicate concentration, a first method for processing the wastewater stream to create a zero liquid discharge stream involves the steps of:
1) Reducing the initial pH of the wastewater stream to achieve a treatment pH range of 6.0-9.0, using, for example, a mineral acid or CO₂;
2) Forming a silica gel;
3) Separating the gel and supernant;
4) Dewatering the gel; and
5) Drying the gel to produce a dry waste stream.

Having obtained this process stream of high silicate, a second method for processing the wastewater stream to create a zero liquid discharge stream involves the steps of:
1) Increasing the initial silica concentration of the wastewater to achieve a treatment silica concentration;
2) Reducing the initial pH of the wastewater stream to achieve a treatment pH range of 6.0-9.0 using, for example, acid or CO₂;
3) Forming a silica gel;
4) Separating the gel and supernant;
5) Dewatering the gel; and
6) Drying the gel to produce a dry waste stream.

Having obtained this process stream of high silicate, a third method for processing the wastewater stream that includes one or more chelants to create a zero liquid discharge stream involves the steps of:
1) Treating the wastewater to reduce the effectiveness of at least one of the chelants present in the wastewater;
2) Reducing the initial pH of the wastewater stream to achieve a treatment pH range of 6.0-9.0 using, for example, acid or CO₂;
3) Forming a silica gel;
4) Separating the gel and supernant;
5) Dewatering the gel; and
6) Drying the gel to produce a dry waste stream.

For treating feedwater streams characterized by high calcium and/or magnesium hardness concentrations, but lower initial silica concentrations, a fourth method for improving the feedwater quality involves the steps of:
1) Increasing the initial silica concentration of the feedwater to achieve a treatment silica concentration;
2) Reducing the initial pH of the feedwater stream to achieve a treatment pH range of 6.0-9.0 using, for example, acid or CO₂;
3) Forming a silica gel;
4) Separating the gel and supernant;
5) Dewatering the gel; and
6) Drying the gel to produce a dry waste stream.

Each of the processes disclosed herein rely on achieving a relatively high silica content in the feedwater/wastewater stream of, for example, about 5000 ppm and more typically about 5000-10,000 ppm of silicate as SiO₂, before initiating the gel formation. Higher silica content streams can also be treated, but tend to raise scale formation concerns for the associated equipment. The pH can be adjusted to, for example, 8.5, using acid(s) and/or a carbon dioxide bubbler. The carbon dioxide source can also be an exhaust gas from hydrocarbon combustion elsewhere in the plant or may be provided through a dedicated source.

Once the treatment pH has been obtained, substantial gel formation is typically observed within about 10 minutes after which centrifugation or other suitable process can be used for separating the silica gel from supernant. The supernant can then be recovered and reused in the basic process as a recycle stream. The extracted gel can then be subjected to further dewatering using, for example, heat, vacuum, filter press and/or any conventional dewatering technique. The gel can be disposed of as a solid waste or reused in one or more industrial processes as, for example, a silica source, or may be pelletized and/or subjected to additional modification through the addition of colorants and/or indicators for use as a desiccant.

### EXAMPLES

An initial concentration of silica containing water was added to the sump of a recirculating evaporator test rig. A stock solution of calcium and magnesium was then prepared and introduced into the silica water. The pH was adjusted to 11.5 using a dilute hydrochloric acid solution to help prevent precipitation of solids. Carbon dioxide was then bubbled through a 100 mL of sample water, acidifying the sample to a treatment pH of 8.6. Each sample was given a fixed sitting time to allow the formation of gel, followed by a 15 minute centrifuge. Analytical tests were then carried out on the supernatant in order to determine the differences in total hardness and silica concentrations. The test was repeated using sulfuric acid for comparison of hardness removal.

Sitting, settling or treatment time was a consideration for developing a sufficient volume of silica gel to remove the hardness effectively. The times given for each sample to settle and their results are shown in TABLE 1. A treatment time between 10-20 minutes at the treatment pH appeared to be sufficient for capturing and removing most of the calcium hardness from of the test solution while 30 minutes resulted in substantially complete calcium hardness removal.

TABLE 1

| Treatment | Ca ppm | Ca ppm | | |
|---|---|---|---|---|
| Time | Stock | Supernatant | % Gel | % Ca Removed |
| 10 | 148.82 | 10.64 | 29.8 | 92.9 |
| 20 | 182.72 | 2.98 | 34.3 | 98.4 |
| 30 | 99.50 | 0.00 | 35.0 | 100.0 |

### The Removal of Calcium Hardness Increased with Longer Treatment Times

Sulfuric acid was also used as an alternative method to CO₂ for reducing the initial pH of the water sample into the treatment pH range. The use of sulfuric acid in this process was not, however, as successful (see TABLE 2) at inducing gel formation despite achieving similar treatment pH ranges. Further, centrifuge treatment times of about 30 minutes were needed to achieve sufficient compaction of the silica gel to allow separation of the silica gel and the supernatant. Calcium removal was not as significant using sulfuric acid compared to the CO₂ bubbling method.

TABLE 2

| | Ca ppm | Ca ppm | | |
|---|---|---|---|---|
| Time | Stock | Supernatant | % Gel | % Ca Removed |
| 10 | 155.14 | 120.16 | 39.3 | 22.6 |
| 20 | 206.02 | 117.68 | 36.0 | 42.9 |
| 30 | 100.43 | 66.35 | 43.3 | 33.9 |

The experimental process was then repeated using a stock solution comprising calcium and magnesium. Full results are shown below in TABLE 3. The gel was able to remove 80.6% of calcium along with substantially complete removal of magnesium.

TABLE 3

| | Stock | Centrifuge |
|---|---|---|
| Analysis | Solution | Supernant |
| pH | 11.49 | 8.73 |
| Conductivity, μmho | 23570 | 26030 |
| “P”-Alkalinity, as CaCO₃, mg/L | 4816 | 404 |
| “M”-Alkalinity, as CaCO₃, mg/L | 6438 | 5820 |
| Calcium Hardness, as CaCO₃, mg/L | 49.441 | 9.581 |
| Magnesium Hardness, as CaCO₃, mg/L | 22.058 | 0 |
| Sodium, as Na, mg/L | 5385 | 5029 |
| Chloride, as Cl, mg/L | 5978 | 6326 |
| Silica, as SiO₂, mg/L | 8766 | 1072 |

### Analytical Results of the Calcium and Magnesium Stock Solution Tests. 39.5% Gel was Formed

After the trials with makeup water, the evaporator water was tested. No adjustments were made prior to acidification. A treatment time of 15 minutes was allowed for gel formation before separating the silica gel and the supernant.

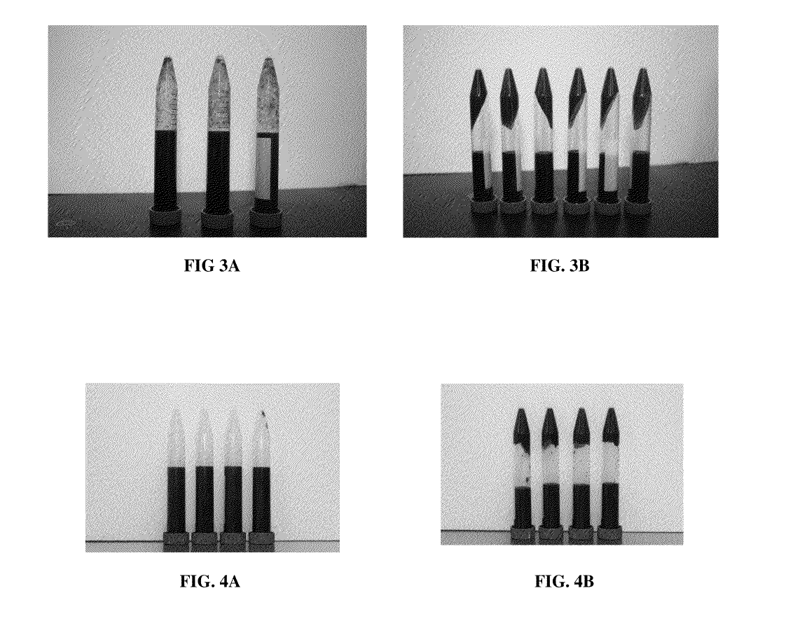

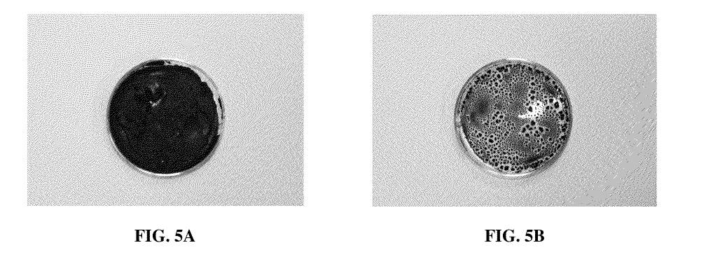

Gel formation was much more noticeable after the pH reduction resulting from the CO₂ bubbling. An average of 27.1% gel was produced from the samples tested in this manner. FIGS. 3A and 3B show representative samples before and after centrifuge. Providing adequate treatment/sitting time provided improved silica gel formation that, in turn, required less centrifuge time to achieve sufficient packing of the silica gel to allow the supernatant to be drawn off for analysis.

The results are shown in Table 4. Hardness removal was not present in this run. This is due to the addition of chelant in the received sump water. A large decrease in silica concentration was shown.

TABLE 4

| | Evaporator | Evaporator |
|---|---|---|
| Analysis | As Received | After Processing |
| pH | 10.84 | 8.64 |
| Conductivity, μmho | 82450 | 85600 |
| “P”-Alkalinity, as CaCO₃, mg/L | 7620 | 917 |
| “M”-Alkalinity, as CaCO₃, mg/L | 14160 | 15848 |
| Calcium Hardness, as CaCO₃, mg/L | 250 | 232 |
| Magnesium Hardness, as CaCO₃, mg/L | 17 | 15 |
| Iron, as Fe, mg/L | <5.0 | <5.0 |
| Copper, as Cu, mg/L | <5.0 | <5.0 |
| Zinc, as Zn, mg/L | <5.0 | <5.0 |
| Sodium, as Na, mg/L | 16127 | 13244 |
| Potassium, as K, mg/L | 733 | 619 |
| Chloride, as Cl, mg/L | 18092 | 18969 |
| Sulfate, as SO₄, mg/L | 182 | 218 |
| Nitrate, as NO₃, mg/L | <10 | <10 |
| Ortho-Phosphate, as PO₄, mg/L | <50 | <0.50 |
| Silica, as SiO₂, mg/L | 25243 | 111 |

SAGD sample, pH reduced to 8.6 by carbon dioxide bubbling, 70% supernant water recovery after centrifuge, 30% gel remaining achieved 99.6% silica removal. In the presence of untreated chelant, no significant reduction in Ca or Mg hardness was achieved. Treatment via pH or other means sufficient to suppress the effectiveness of the chelant in the sample will tend to increase the removal of the Ca and/or Mg hardness.

Overnight drying at 70° C. of the extracted silica gel, having an original mass of 10.015 g, produced a solid having a mass of 1.069 g, indicating that the gel as produced in this example comprised about 10.7% solids.

In a normal blowdown, cycled water is released in order to prevent scale build up, and then new water is added to maintain system volume. By utilizing a zero blowdown system, industries can save cost associated with water replenishment and liquid waste disposal. The zero liquid discharge process according to the invention can be used to treat this blowdown stream to form a gel containing the majority of the silicon, calcium and magnesium from the blowdown stream. This gel can then be drawn off via mechanical separation for further treatment and/or disposal with the supernatant being fed back into the system as a recycle stream.

We claim:

1. A method of treating an aqueous alkaline stream having a high silica content in order to reduce liquid discharge comprising:
reducing an initial pH of the aqueous stream to a treatment pH sufficient to induce formation of a silica gel and a supernant; and
separating the silica gel from the supernant.

2. The method of treating an aqueous alkaline stream having a high silica content in order to reduce liquid discharge according to claim 1, further comprising:
dewatering the silica gel.

3. The method of treating an aqueous alkaline stream having a high silica content in order to reduce liquid discharge according to claim 1, further comprising:
drying the dewatered silica gel to form a dry waste stream.

4. The method of treating an aqueous alkaline stream having a high silica content in order to reduce liquid discharge according to claim 1, further comprising:
recycling the supernant.

5. The method of treating an aqueous alkaline stream having a high silica content in order to reduce liquid discharge according to claim 1, wherein:
the aqueous alkaline stream includes at least 1000 ppm silica.

6. The method of treating an aqueous alkaline stream having a high silica content in order to reduce liquid discharge according to claim 1, wherein:
the aqueous alkaline stream includes at least 5000 ppm silica.

7. The method of treating an aqueous alkaline stream having a high silica content in order to reduce liquid discharge according to claim 1, wherein:
the treatment pH is no greater than 9.0.

8. The method of treating an aqueous alkaline stream having a high silica content in order to reduce liquid discharge according to claim 1, wherein:
the treatment pH is no greater than 7.0.

9. The method of treating an aqueous alkaline stream having a high silica content in order to reduce liquid discharge according to claim 1, wherein:
reducing the initial pH of the aqueous alkaline stream further comprises injecting carbon dioxide into the aqueous alkaline stream.

10. The method of treating an aqueous alkaline stream having a high silica content in order to reduce liquid discharge according to claim 1, further comprising:
increasing an initial silica content of the aqueous alkaline stream to achieve a treatment silica content before reducing the initial pH of the aqueous alkaline stream.

11. The method of treating an aqueous alkaline stream having a high silica content in order to reduce liquid discharge according to claim 10, wherein:
the treatment silica content is at least 5000 ppm silica.

12. The method of treating an aqueous alkaline stream having a high silica content in order to reduce liquid discharge according to claim 1, further comprising:
treating the aqueous alkaline stream to suppress the effectiveness of a chelant compound present in the aqueous alkaline stream before reducing the initial pH.

13. The method of treating an aqueous alkaline stream having a high silica content in order to reduce liquid discharge according to claim 1, further comprising:
maintaining the treatment pH for a treatment period sufficient to capture at least 90% of the silica content of the aqueous alkaline stream in the silica gel before separating the silica gel from the supernant.

14. The method of treating an aqueous alkaline stream having a high silica content in order to reduce liquid discharge according to claim 13, further comprising:
maintaining the treatment pH for a treatment period sufficient to capture at least 98% of the silica content of the aqueous alkaline stream in the silica gel.
